(19) United States
(12) Patent Application Publication
(10) Pub. No.: US 2008/0224915 A1
(43) Pub. Date: Sep. 18, 2008

(54) System and method for effectively implementing a universal remote control device

(75) Inventors: Robert Unger, El Cajon, CA (US); Jean-Pierre Guillou, San Diego, CA (US)

Correspondence Address: Gregory J. Koerner;Redwood Patent Law, 1291 East Hillsdale Boulevard, Suite 205, Foster City, CA, 94404, US

(73) Assignee: Sony Corporation and Sony Electronics Inc.

(21) Appl. No.: 11/717,297

(22) Filed: Mar. 13, 2007

(51) Int. Cl. G08C 19/12

(52) U.S. Cl. 341/176

(57) ABSTRACT

A system and method for effectively implementing a universal remote control device comprises a configurable control assembly that includes an LCD panel for selectively displaying appropriate sets of control symbols that represent control commands for controlling a plurality of different electronic devices. Device control information for the various different electronic devices may be downloaded into the remote control device to support various desired device control modes for controlling the different respective electronic devices. The control assembly also includes a switch matrix that is transparently implemented to include control switches that are each aligned over a corresponding respective one of the control symbols on the LCD panel. The control assembly further includes a button panel with control buttons that are transparently positioned to permit viewing the control symbols on the display panel through the control buttons. The control buttons may thus be utilized for activating aligned control switches to thereby select corresponding ones of the control commands.

### BACKGROUND SECTION

1. Field of the Invention

This invention relates generally to techniques for controlling electronic devices, and relates more particularly to a system and method for effectively implementing a universal remote control device.

2. Description of the Background Art

Implementing effective methods for controlling electronic devices is a significant consideration for designers and manufacturers of contemporary electronic systems. However, effectively controlling electronic devices may create substantial challenges for system designers. For example, enhanced demands for increased control functionality and device performance may require more operating power and require additional hardware resources. An increase in power or hardware requirements may also result in a corresponding detrimental economic impact due to increased production costs and operational inefficiencies.

Furthermore, enhanced device capabilities to perform various advanced control operations may provide additional benefits to a system user, but may also place increased demands on the control and management of various system components. For example, an enhanced control system that effectively controls television systems may benefit from an efficient implementation because of the variety and complexity of the different electronic devices involved.

Due to growing demands on device control functionality and substantially increasing system complexity, it is apparent that developing new techniques for controlling electronic systems is a matter of concern for related electronic technologies. Therefore, for all the foregoing reasons, developing effective techniques for providing appropriate device-control functionality remains a significant consideration for designers, manufacturers, and users of contemporary electronic devices.

### SUMMARY

In accordance with the present invention, a system and method are disclosed for effectively implementing a universal remote control device. In one embodiment, a television system includes a television, a settop box, a configuration server, a personal computer, and a remote control for controlling the television system. The remote control is advantageously implemented with a configurable control assembly that includes, but is not limited to, a backlight array, a liquid-crystal display (LCD) panel, a switch matrix, a button panel, and an assembly cover.

The backlight array may be implemented in any effective manner to provide discrete light sources that are intended to be aligned with corresponding control button positions on the button panel, and with the other superimposed layers of the control assembly. In certain embodiments, the remote control may selectively turn on the backlight array when ambient lighting conditions make backlighting necessary. Alternately, when sufficient ambient light is available, the backlight array may be advantageously turned off to conserve operating power for the remote control.

In accordance with the present invention, an RC configuration manager of the remote control may flexibly generate appropriate control symbols on the LCD panel to support any desired electronic device in the television system. The LCD panel may be positioned directly over the backlight array so that each of the control symbols are aligned with a corresponding backlight source on the backlight array. The LCD panel may be implemented in any effective and appropriate manner. For example, the LCD panel may be implemented as an LCD pixel array (color or monochrome) that allows backlight from the backlight array to pass only through those pixels that currently create the respective control symbols.

The switch matrix is implemented in a transparent manner with appropriate control switches that are aligned with corresponding control button positions on the button panel. The switch matrix may be implemented in any effective manner to respond to pressure from the control buttons on the button panel to thereby close corresponding control switches for indicating the selection of an associated control symbol on the LCD panel.

The button panel includes a series of transparent control buttons that permit a system user to view the configurable control symbols that are generated on the LCD panel. In certain embodiments, the button panel may be economically manufactured as a single monolithic button panel in which the control buttons are integrally molded from any effective type of flexible material. The assembly cover may be implemented with button cutouts that fit over corresponding control buttons of the button panel.

In accordance with one embodiment of the present invention, an RC configuration manager of the remote control may initially download RC configuration information from a configuration server by utilizing any effective and appropriate techniques. For example, in certain embodiments, the settop box may download the RC configuration information from the configuration server over the Internet. The remote control may then download the RC configuration information from the settop box via a wireless radio-frequency communications link.

Alternately, the personal computer may download the RC configuration information from the configuration server over the Internet. The remote control may then download the RC configuration information from the computer via a hard-wired dataport. The downloaded RC configuration information may include specific control commands and related information for controlling the television, the settop box, and other electronic devices in the television system.

A system user may then utilize the RC configuration manager of the remote control to associate particular control commands with corresponding control buttons on the control assembly in any effective manner. For example, an RC configuration module of the settop box may provide a configuration graphical-user-interface (configuration GUI) upon the television to allow the system user to associate the control commands with the appropriate control buttons on the remote control. The system user may also utilize the RC configuration manager to choose specific control symbols for corresponding control buttons on the control assembly by performing any effective selection process. For example, the RC configuration module of the settop box may provide a configuration GUI upon the television to allow the system user to associate desired control symbols with corresponding control buttons on the remote control.

The system user may then utilize the control assembly of the remote control to select a particular device control mode (to specify a device to be controlled) in any effective manner. For example, the system user may scroll through various supported devices in an LCD display window on the remote control before making a selection. In response to the foregoing device control mode selection, the RC configuration manager of the remote control may advantageously access the downloaded RC configuration information to display the appropriate control symbols for the remote control to generate appropriate control commands for the selected device control mode. For at least the foregoing reasons, the present invention thus provides an improved a system and method for effectively implementing a universal remote control device.

### BRIEF DESCRIPTION OF THE DRAWINGS

FIG. 1 is a block diagram of a television system, in accordance with one embodiment of the present invention;

FIG. 2 is a block diagram for one embodiment of the settop box of FIG. 1, in accordance with the present invention;

FIG. 3 is a block diagram for one embodiment of the STB memory of FIG. 2, in accordance with the present invention;

FIG. 4 is a block diagram for one embodiment of the remote control of FIG. 1, in accordance with the present invention;

FIG. 5 is a block diagram for one embodiment of the RC memory of FIG. 4, in accordance with the present invention;

FIG. 6 is an expanded-layout diagram for one embodiment of the control assembly of FIG. 4, in accordance with the present invention;

FIG. 7 is a block diagram for one embodiment of a control button of FIG. 6, in accordance with the present invention;

FIG. 8 is a flowchart of method steps for implementing a configurable control assembly, in accordance with one embodiment of the present invention; and

FIG. 9 is a flowchart of method steps for performing a remote control configuration procedure, in accordance with one embodiment of the present invention.

### DETAILED DESCRIPTION

The present invention relates to an improvement in remote control systems. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for effectively implementing a universal remote control device, and comprises a configurable control assembly that includes an LCD panel for selectively displaying appropriate sets of control symbols that represent control commands for controlling a plurality of different electronic devices. Device control information for the various different electronic devices may be downloaded into the remote control device to support various desired device control modes for controlling the different respective electronic devices.

The control assembly also includes a switch matrix that is transparently implemented to include control switches that are each aligned over a corresponding respective one of the control symbols on the LCD panel. The control assembly further includes a button panel with control buttons that are transparently positioned to permit viewing the control symbols on the display panel through the control buttons. The control buttons may thus be utilized for activating aligned control switches to thereby select corresponding ones of the control commands.

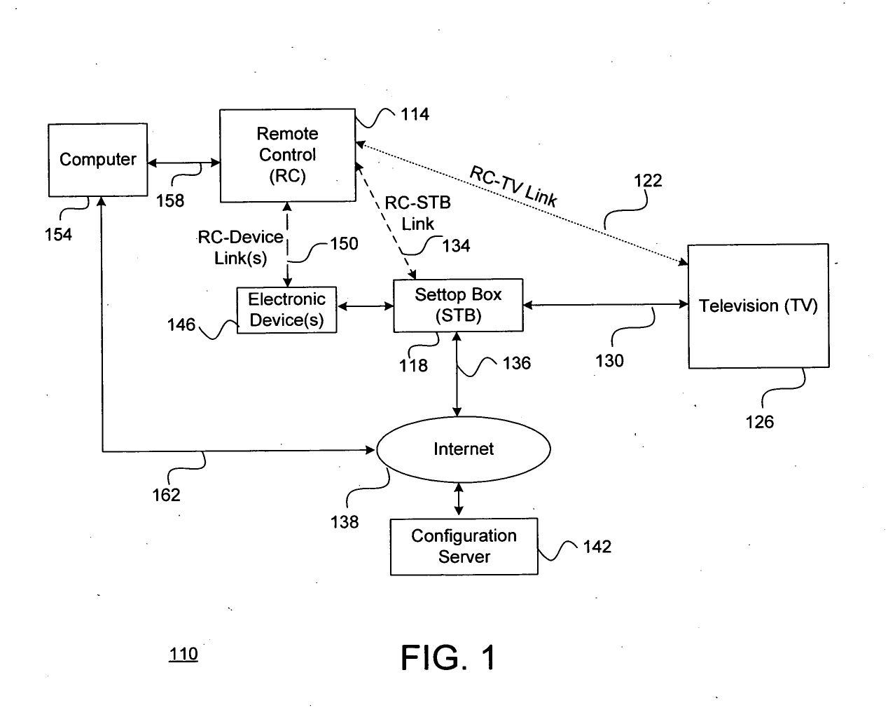

Referring now to FIG. 1, a block diagram of a television system 110 is shown, in accordance with one embodiment of the present invention. In the FIG. 1 embodiment, television system 110 may include, but is not limited to, a remote control (RC) 114, a settop box (STB) 118, a television (TV) 126, a configuration server 142, one or more electronic devices 146, and a computer 154. In alternate embodiments, television system 110 may be implemented using components and configurations in addition to, or instead of, certain of those components and configurations discussed in conjunction with the FIG. 1 embodiment.

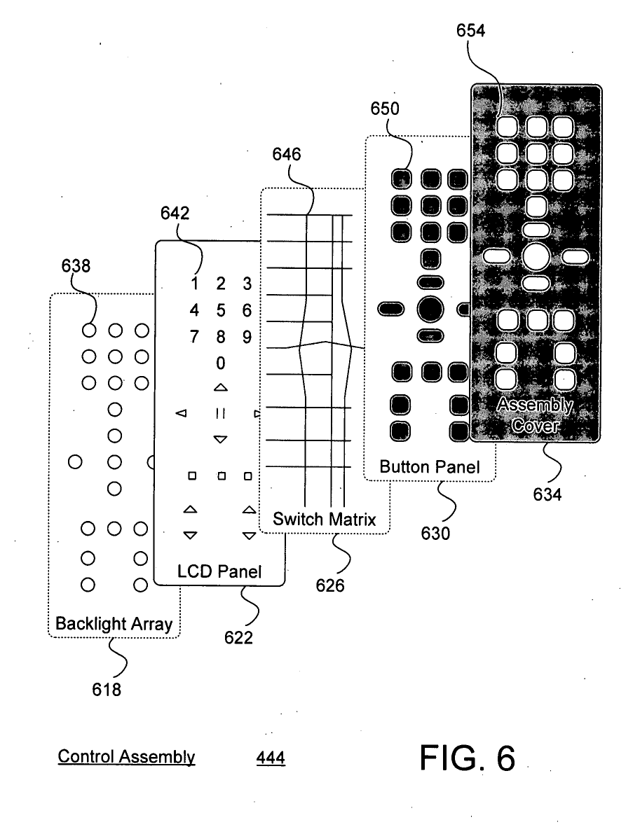

In the FIG. 1 embodiment, remote control 114 is implemented to incorporate appropriate control functionalities for utilizing television 126, STB 118, and one or more other electronic devices 146 of television system 110 in an optimal manner. In accordance with the present invention, a configurable control assembly (not shown) of remote control 114 may be advantageously configured through a remote control configuration procedure to provide selectable control functions to fully support the various electronic devices of television system 110. The implementation and operation of the foregoing control assembly of remote control 114 is further discussed below in conjunction with FIGS. 6-9.

In the FIG. 1 embodiment, remote control 114 may bi-directionally and wirelessly communicate with either STB 118 via RC-STB link 134, television 126 via RC-TV link 122, or electronic device(s) 146 via RC-device link(s) 150 by utilizing any appropriate communication techniques. For example, in certain embodiments, remote control 114 may provide low-speed control information by utilizing infrared (IR) transmission techniques. In addition, in certain embodiments, remote control 114 may utilize appropriate low-speed or high-speed radio-frequency (RF) transmission techniques to transfer any desired types of electronic information.

In the FIG. 1 embodiment, remote control 114 may also bi-directionally communicate with a computer 154 via path 158 to exchange any desired types of information by utilizing any effective transfer formats or techniques. In the FIG. 1 embodiment, STB 118 may be implemented as any type of electronic device to perform any desired types of control functions for television system 110. In the FIG. 1 embodiment, either STB 118 or computer 154 may be coupled through the Internet 138 (or other connecting entity) to a configuration server 142 that provides various types of configuration support and configuration functionalities for performing a configuration procedure to flexibly configure the control assembly (see FIG. 6) of remote control 114.

The FIG. 1 embodiment of the present invention is described in the context of television system 110. However, the concepts and principles of the present invention may be readily applied to any suitable type of electronic devices or systems that are remotely controllable. Various techniques for flexibly implementing and configuring remote control 114 are further discussed below in conjunction with FIGS. 6-9.

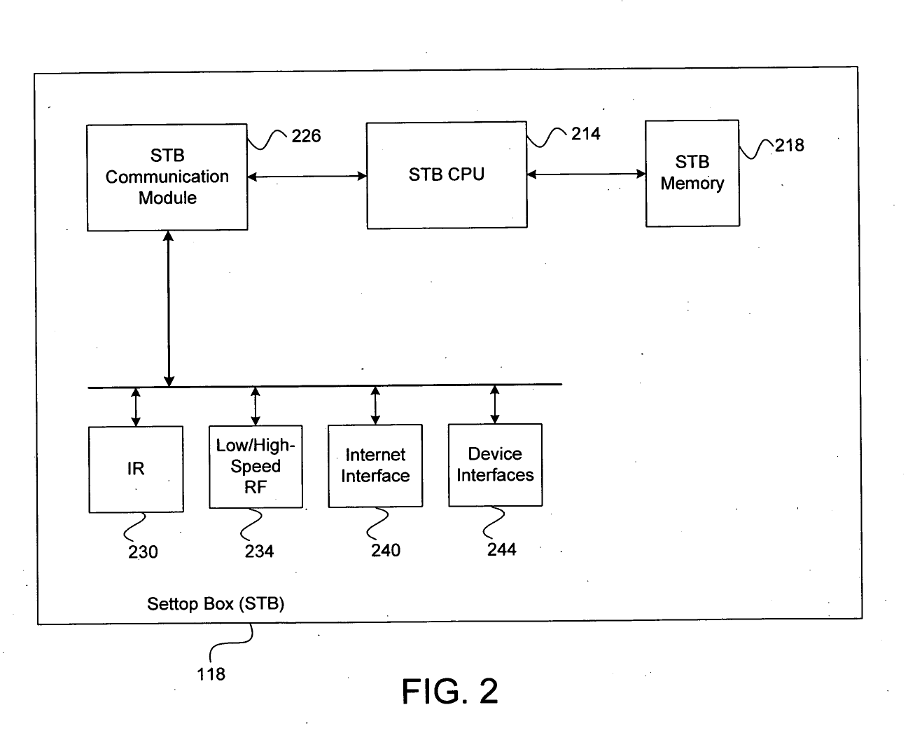

Referring now to FIG. 2, a block diagram for one embodiment of the FIG. 1 settop box (STB) 118 is shown, in accordance with the present invention. In alternate embodiments, STB 118 may include components and configurations in addition to, or instead of, certain of those components and configurations discussed in conjunction with the FIG. 2 embodiment.

In the FIG. 2 embodiment, STB 118 includes an STB central processing unit (STB CPU) 214 that may be implemented to include any appropriate and compatible microprocessor device (including system-on-chip (SOC) architectures). In the FIG. 2 embodiment, STB CPU 214 preferably executes software instructions from one or more software programs to thereby control and manage the operation of STB 118. In the FIG. 2 embodiment, STB memory 218 may be implemented to include any combination of desired storage devices, including, but not limited to, read-only memory (ROM), random-access memory (RAM), and various types of non-volatile memory, such as floppy disks or hard disks.

In the FIG. 2 embodiment, STB 118 includes an STB communication module 226 that cooperates with STB CPU 214 to perform and coordinate various types of bi-directional wireless and wired communications between STB 118 and other entities. The FIG. 2 embodiment also includes a series of STB input/output interfaces that STB communication module 226 may utilize to receive and/or transmit any required types of information. For example, in the FIG. 2 embodiment, the STB input/output interfaces include, but are not limited to, an infrared (IR) interface 230, a low/high-speed radio frequency (RF) interface 234, an Internet interface 240, and one or more device interfaces 244

In the FIG. 2 embodiment, STB communication module 226 may utilize IR interface 230 to receive control information and other appropriate information from remote control 114 (FIG. 1) by utilizing any effective infrared transmission techniques. In certain embodiments, IR interface 230 may also transmit infrared information to remote control 114. In the FIG. 2 embodiment, STB communication module 226 may optionally utilize low/high-speed RF interface 234 to bi-directionally and wirelessly communicate with remote control 114 by utilizing any effective low-speed or high-speed RF transmission techniques at any appropriate frequencies. For example, in the FIG. 2 embodiment, high-speed RF transmissions may operate in the approximate range of 100 megabits-per-second. In certain embodiments, STB 118 may utilize low/high-speed RF interface 234 to transfer remote control configuration information to remote control 114 during a remote control configuration procedure, as previously discussed above in conjunction with FIG. 1.

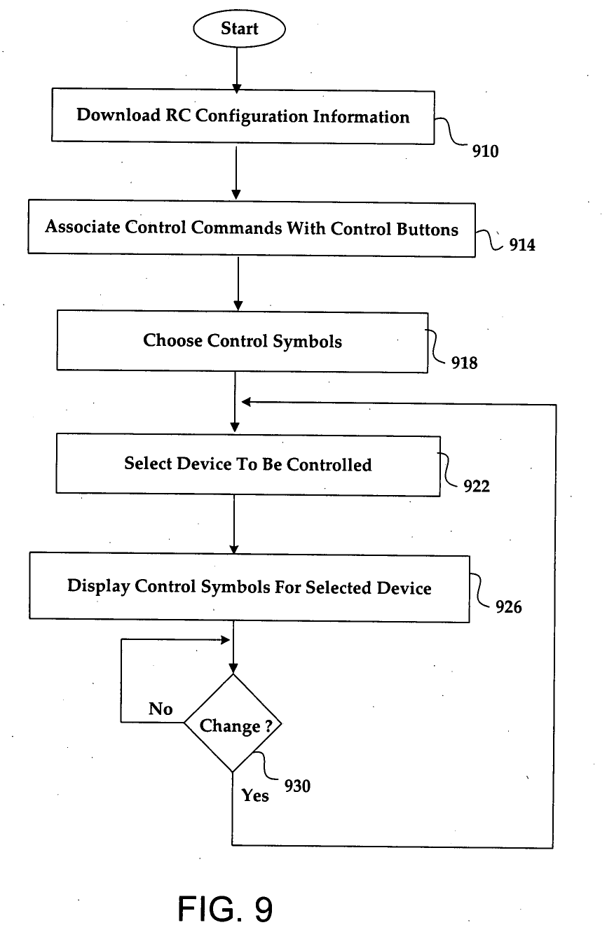

In the FIG. 2 embodiment, STB communication module 226 may utilize Internet interface 240 to perform any compatible network data-transfer procedures to any appropriate types of distributed computer networks, including, but not limited to, the Internet. In the FIG. 2 embodiment, STB 118 may utilize Internet interface 240 to bi-directionally communicate with configuration server 142 (FIG. 1). In the FIG. 2 embodiment, STB communication module 226 may utilize device interfaces 244 to effectively communicate with (and control) one or more electronic devices 146 (FIG. 1) in television system 110. The utilization of STB 118 is further discussed below in conjunction with FIG. 9.

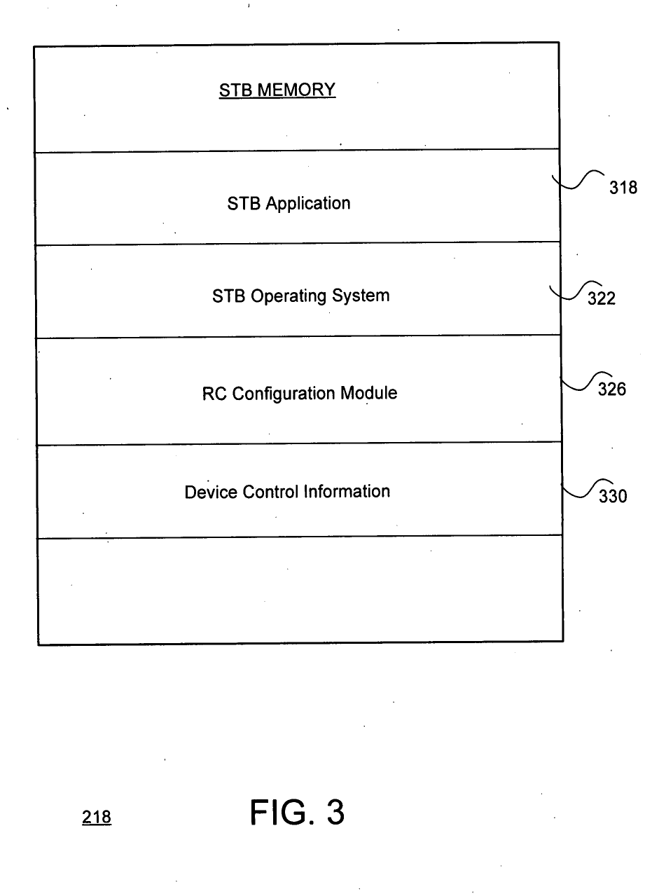

Referring now to FIG. 3, a block diagram of an STB memory 218 from the FIG. 2 STB 118 is shown, in accordance with one embodiment of the present invention. In the FIG. 3 embodiment, STB memory 218 includes, but is not limited to, an STB application 318, an STB operating system 322, an RC configuration module 326, and device control information 330. The FIG. 3 embodiment is presented for purposes of illustration, and in alternate embodiments, STB memory 218 may be implemented using components and configurations in addition to, or instead of, certain of those components and configurations discussed in conjunction with the FIG. 3 embodiment.

In the FIG. 3 embodiment, STB memory 218 stores an STB application 318 which includes program instructions that are executed by STB CPU 214 (FIG. 2) to perform various functions and operations for STB 118. The particular nature and functionality of STB application 318 typically varies depending upon factors such as the specific type and functionality of the corresponding STB 118. In the FIG. 3 embodiment, STB memory 218 may also store a STB operating system 322 that controls and coordinates low-level functionality of STB 118.

In the FIG. 3 embodiment, STB memory 218 may also include an RC configuration module 326 with program instructions that STB CPU 214 executes to support various remote control configuration procedures to effectively provide additional device control information 330 (including remote control configuration information) to remote control 114, as discussed above in conjunction with FIG. 1. Various techniques for selectively configuring remote control 114 are further discussed below in conjunction with FIG. 9.

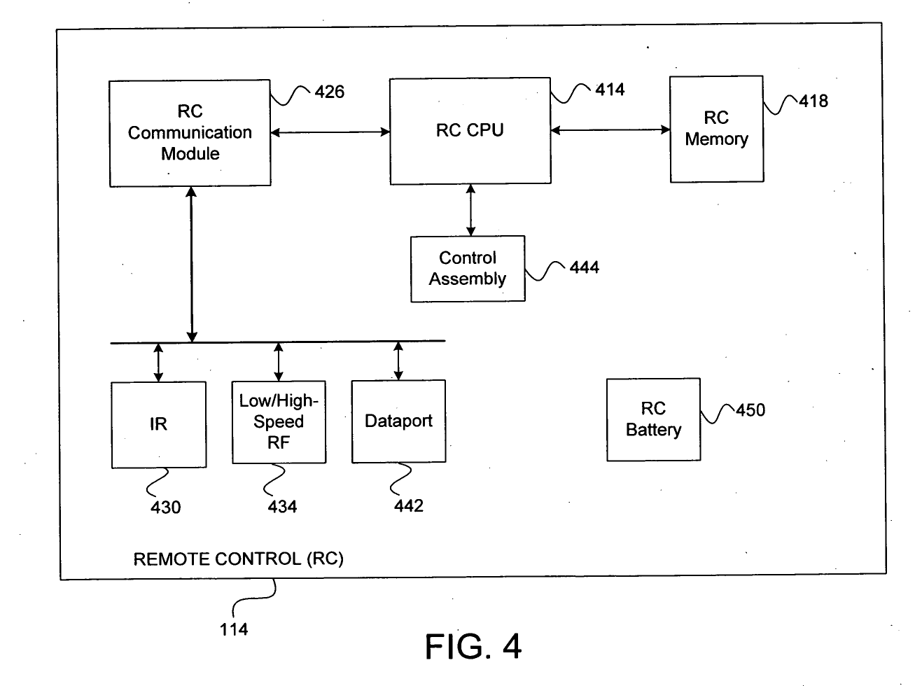

Referring now to FIG. 4, a block diagram for one embodiment of the FIG. 1 remote control (RC) 114 is shown, in accordance with the present invention. In alternate embodiments, remote control 114 may include components and configurations in addition to, or instead of, certain of those components and configurations discussed in conjunction with the FIG. 4 embodiment.

In the FIG. 4 embodiment, remote control 114 includes a remote control central processing unit (RC CPU) 414 that may be implemented to include any appropriate and compatible microprocessor device. In the FIG. 4 embodiment, RC CPU 414 preferably executes software instructions from one or more applications programs to thereby control and manage the operation of remote control 114. In the FIG. 4 embodiment, RC memory 418 may be implemented to include any combination of desired storage devices, including, but not limited to, read-only memory (ROM), random-access memory (RAM), and various types of non-volatile memory.

In the FIG. 4 embodiment, remote control 114 includes an RC communication module 426 that cooperates with RC CPU 414 to perform and coordinate various types of bi-directional wireless and wired communications between remote control 114 and other entities. The FIG. 4 embodiment also includes a series of RC input/output interfaces that RC communication module 426 may utilize to receive and/or transmit any required types of information. For example, in the FIG. 4 embodiment, the RC input/output interfaces include, but are not limited to, an infrared (IR) interface 430, a low/high-speed radio frequency (RF) interface 434, and a dataport 442.

In the FIG. 4 embodiment, RC communication module 426 may utilize IR interface 430 to send control information and other appropriate information directly to television 126, STB 118, or one or more other electronic devices 146 (FIG. 1) by utilizing any effective infrared transmission techniques. In certain embodiments, IR interface 330 may also receive infrared information from STB 118 or other external entities. In the FIG. 4 embodiment, RC communication module 426 may utilize low/high-speed RF interface 434 to bi-directionally and wirelessly communicate with television 126, STB 118, or other electronic devices 146 by utilizing any effective RF transmission techniques at any appropriate low or high RF frequencies. In certain embodiments, remote control 114 may utilize low/high-speed RF interface 434 to transfer RC configuration information from STB 118 during a remote control configuration procedure as discussed above in conjunction with FIG. 1.

In the FIG. 4 embodiment, RC communication module 426 may utilize dataport 442 to bi-directionally communicate with any desired external entities. For example, in certain embodiments, remote control 114 may utilize dataport 442 to connect to a computer 154 for downloading appropriate RC configuration information to selectively configure a control assembly 444 of remote control 114 to thereby control a plurality of different devices in television system 110. In certain embodiments, dataport 442 may be implemented according to a known Universal Serial Bus (USB) standard to promote compatibility with various types of computer devices. Effective techniques for implementing and utilizing control assembly 444 of remote control 114 are further discussed below in conjunction with FIGS. 6-9.

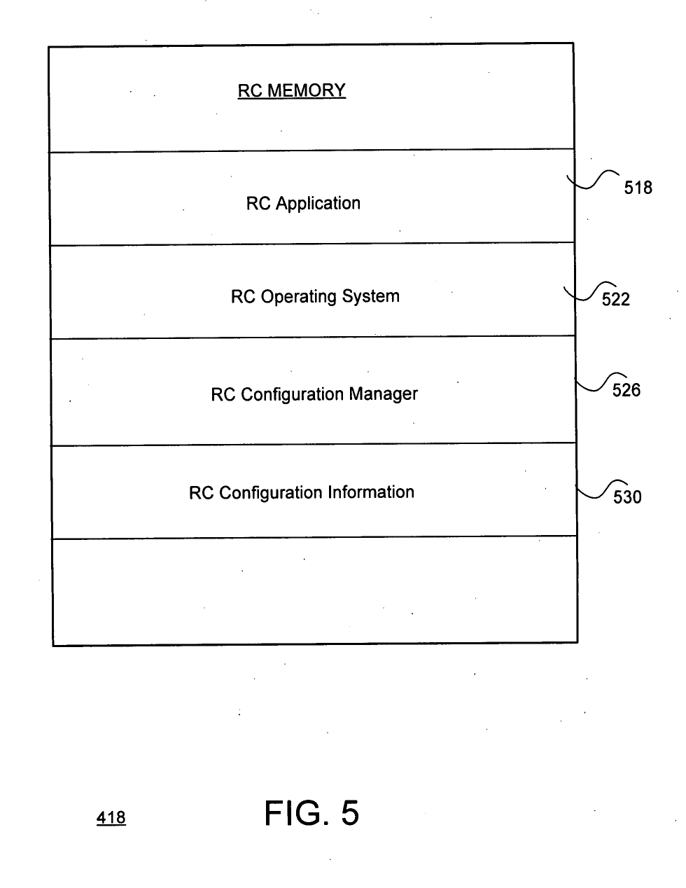

Referring now to FIG. 5, a block diagram of the RC memory 418 from the FIG. 4 remote control 114 is shown, in accordance with one embodiment of the present invention. In the FIG. 5 embodiment, RC memory 418 includes, but is not limited to, an RC application 518, an RC operating system 522, an RC configuration manager 526, and RC configuration information 530. The FIG. 5 embodiment is presented for purposes of illustration, and in alternate embodiments, RC memory 418 may be implemented using components and configurations in addition to, or instead of, certain of those components and configurations discussed in conjunction with the FIG. 5 embodiment.

In the FIG. 5 embodiment, RC memory 418 stores an RC application 518 which includes program instructions that are executed by RC CPU 414 (FIG. 4) to perform various functions and operations for remote control 114. The particular nature and functionality of RC application 518 typically varies depending upon factors such as the specific type and functionality of the corresponding remote control 114. In the FIG. 5 embodiment, RC memory 418 may also store an RC operating system 522 that controls and coordinates low-level functionality of remote control 114.

In the FIG. 5 embodiment, RC memory 418 may also include an RC configuration manager 526 with program instructions that RC CPU 414 executes to support various remote control configuration procedures to effectively provide additional control functionality for remote control 114, as discussed above in conjunction with FIG. 1. In addition, in certain embodiments of the present invention, RC memory 418 may store RC configuration information 530 that specifies various parameters for the control functionalities of remote control 114. For example, in certain embodiments, configuration information 530 may include control commands that remote control 114 transmits to control the operation of various associated devices.

Referring now to FIG. 6, an expanded-layout diagram for one embodiment of the FIG. 4 control assembly is shown, in accordance with the present invention. In the FIG. 6 embodiment, control assembly includes, but is not limited to, a backlight array 618, a liquid-crystal display (LCD) panel 622, a switch matrix 626, a button panel 630, and an assembly cover 634. The FIG. 6 control assembly 444 is presented for purposes of illustration, and in various alternate embodiments, control assembly 444 may be implemented using components and configurations in addition to, or instead of, certain of those components and configurations discussed below in conjunction with the FIG. 6 embodiment. For example, the various layers of control assembly 444 may be implemented to include any desired arrangement of buttons or other control means. In addition, in certain embodiments, control assembly 444 may also include an LCD display window that is not shown in the FIG. 6 embodiment.

In the FIG. 6 diagram, backlight array 618, LCD panel 622, switch matrix 626, button panel 630, and assembly cover 634 are shown as separate assembly layers. However, during a manufacturing process, these separate layers may then be directly superimposed over each other and connected in the order shown to finalize control assembly 444 for utilization in remote control 114. In the FIG. 6 embodiment, backlight array 618 may be implemented in any effective manner to provide discrete light sources that are intended to be aligned with corresponding control button positions on button panel 630, and with the other superimposed layers of control assembly 444 after control assembly 444 has been completed.

For example, a backlight source 638 may be aligned with a control button position corresponding to control button 650 of button panel 630. In certain other embodiments, backlight array 618 may be alternately implemented as single monolithic light source, or any other effective lighting arrangement or configuration. In certain embodiments, remote control 114 may selectively turn on backlight array 618 when ambient lighting conditions make backlighting necessary. Alternately, when sufficient ambient light is available, backlight array 618 may be advantageously turned off to conserve the operating power of remote control 114.

In the FIG. 6 embodiment, for purposes of illustration, LCD panel 622 is depicted displaying an exemplary set of control symbols. For example, a control symbol 642 displays the numeral “1.” In accordance with the present invention, an RC configuration manager 526 (FIG. 5) of remote control 114 may flexibly generate appropriate control symbols on LCD panel 622 to support any desired device in television system 110 (FIG. 1). In the FIG. 6 embodiment, LCD panel 622 may be positioned directly over backlight array 618 so that each of the control symbols are aligned with a corresponding backlight source on backlight array 618. For example, control symbol 642 may be aligned directly over backlight source 638.

In the FIG. 6 embodiment, LCD panel 622 may be implemented in any effective and appropriate manner. For example, LCD panel 622 may be implemented as an LCD pixel array (color or monochrome) that allows backlight from backlight array 618 to pass only through those pixels that are currently being illuminated to create the respective control symbols. In addition, in certain embodiments, LCD panel 622 may be alternately implemented by utilizing any effective display technologies other than the liquid-crystal display technology shown in the FIG. 6 embodiment. In certain embodiments, LCD panel 622 may include an LCD display window for displaying text or images to a system user.

In the FIG. 6 embodiment, switch matrix 626 is implemented in a transparent manner with appropriate control switches that are aligned with corresponding control button positions on button panel 630 after the manufacture of control assembly 444 has been completed. For example, a control switch 646 may be aligned with a corresponding control button 650. In the FIG. 6 embodiment, switch matrix 626 may be implemented in any effective manner to respond to pressure from control buttons on button panel 630 to thereby close corresponding control switches for indicating the selection of an associated control symbol on LCD panel 622.

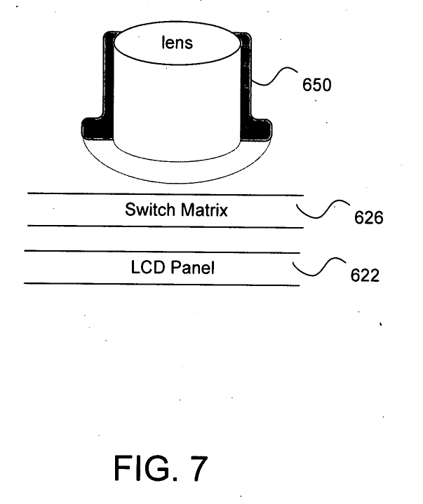

In the FIG. 6 embodiment, button panel 630 includes a series of transparent control buttons that permit a system user to view the configurable control symbols that are generated on LCD panel 622. The FIG. 6 configuration of control buttons is presented for purposes of illustration, and in alternate embodiments, any other effective and appropriate configuration is equally contemplated. One embodiment for a control button is further discussed below in conjunction with FIG. 7. In certain embodiments, button panel 630 may be economically manufactured as a single monolithic button panel in which the control buttons are integrally molded from any effective type of flexible rubber-like material.

In the FIG. 6 embodiment, assembly cover 634 may be implemented with button cutouts that fit over corresponding control buttons of button panel 630. For example, a button cutout 654 may aligned with a corresponding control button 650 on button panel 630. After completing the manufacturing procedure, control assembly 444 thus provides an effective and improved means for flexibly configuring remote control 114 to support the various different electronic devices in television system 110. Additional details regarding the functionality and implementation of control assembly 444 are further discussed below in conjunction with FIGS. 7-9.

Referring now to FIG. 7, a diagram of a FIG. 6 control button 650 is shown, in accordance with one embodiment of the present invention. The FIG. 7 embodiment is presented for purposes of illustration, and in alternate embodiments, control buttons 650 may be implemented using components and configurations in addition to, or instead of, certain of those components and configurations discussed in conjunction with the FIG. 7 embodiment.

In the FIG. 7 embodiment, control button 650 is implemented with a central transparent lens portion through which a control symbol generated on LCD panel 622 may be viewed by a system user. In the FIG. 7 embodiment, the system user may activate a control switch on switch matrix 626 by physically depressing control button 650 to close the corresponding control switch. The system user may thus select the control command represented by the displayed control symbol on LCD panel 622. In certain embodiments of the present invention, button panel 630 (FIG. 6) may be implemented with an array of discrete control buttons 650 to advantageously support tactile utilization of remote control 114 by a system user. Allowing a system user to physically detect the various control buttons on remote control 114 may thus facilitate a more user-friendly and effective utilization of remote control 114.

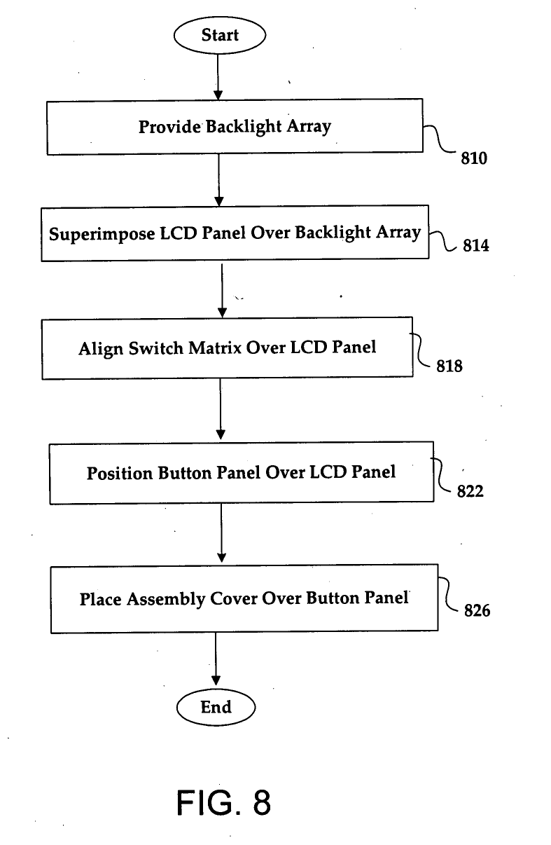

Referring now to FIG. 8, a flowchart of method steps for implementing a configurable control assembly 444 is shown, in accordance with one embodiment of the present invention. The FIG. 8 flowchart is presented for purposes of illustration, and in alternate embodiments, the present invention may implement control assemblies by utilizing steps and sequences other than certain of those steps and sequences discussed in conjunction with the FIG. 8 embodiment.

In the FIG. 8 embodiment, in step 810, a backlight array 618 of discrete backlights is initially provided. Then, in step 814, an LCD panel 622 is superimposed over the backlight array 618 for displaying configurable control symbols to a system user. In step 818, a transparent switch matrix 818 of control switches is aligned over the LCD panel 622. Next, a button panel 630 of transparent control buttons is positioned over the switch matrix 626 so that each control button is aligned with both a corresponding control switch from the switch matrix 626, and with a corresponding control symbol from the LCD panel 622. Finally, in step 826, an assembly cover 634 with button cutouts is placed over the control buttons of the button panel 630. The configurable control assembly 444 is then complete, and the FIG. 8 process may terminate.

Referring now to FIG. 9, a flowchart of method steps for performing a remote control configuration procedure is shown, in accordance with one embodiment of the present invention. The FIG. 9 flowchart is presented for purposes of illustration, and in alternate embodiments, the present invention may perform remote control configuration procedures by utilizing steps and sequences other than certain of those steps and sequences discussed in conjunction with the FIG. 9 embodiment.

In the FIG. 9 embodiment, in step 910, an RC configuration manager 526 (FIG. 5) of remote control 114 initially downloads RC configuration information 530 (FIG. 5) from a configuration server 142 (FIG. 1) by utilizing any effective and appropriate techniques. For example, in certain embodiments, a settop box 118 (FIG. 1) may download the RC configuration information 530 from a configuration server 142 (FIG. 1) over the Internet 138. Remote control 114 may then download the RC configuration information 530 from settop box 118 via RC-STB link 134 (FIG. 1). Alternately, a personal computer 154 (FIG. 1) may download the RC configuration information 530 from configuration server 142 over the Internet 138. Remote control 114 may then download the RC configuration information 530 from the computer 154 via a dataport 442 (FIG. 4). The RC configuration information 530 may include specific control commands and related information for controlling television 126, settop box 118, and other electronic devices 146 in television system 110 (FIG. 1).

In step 914, a system user may then utilize RC configuration manager 526 of remote control 114 to associate particular control commands with corresponding control buttons on control assembly 444 (FIG. 6) in any effective manner. For example, an RC configuration module 326 of settop box 118 may provide a configuration graphical-user-interface (configuration GUI) upon television 126 to allow the system user to associate the control commands with the appropriate control buttons on remote control 114.

In step 918, a system user may also utilize RC configuration manager 526 to choose specific control symbols for the corresponding control buttons on control assembly 444 by performing any effective selection process. For example, the RC configuration module 326 of settop box 118 may provide a configuration GUI upon television 126 to allow the system user to associate desired control symbols with corresponding respective control buttons on remote control 114.

In step 922, a system user may then utilize control assembly 444 of remote control 114 to select a particular device control mode (to specify a device to be controlled) in any effective manner. For example, the system user may scroll through various supported devices in an LCD display window on remote control 114 before making a selection. In certain embodiments, a specified control button on control assembly 444 may be depressed to enter a device select mode in which one of several other predefined control buttons may then be pressed to select a corresponding controlled device.

In response to the foregoing device control mode selection, in step 926, the RC configuration manager 526 may advantageously access downloaded RC configuration information 530 to display the appropriate control symbols and generate appropriate control commands for the selected device control mode. In step 930, if other device control modes are desired, then the FIG. 9 process may return to step 922 to repeatedly select other device control modes, and then display appropriate control labels for generating the correct control commands for the selected devices. For at least the foregoing reasons, the present invention thus provides an improved a system and method for effectively implementing a universal remote control device.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. For example, the invention has been discussed in the context of configuring remote control 114 to include additional control functionalities for devices in television system 110 (FIG. 1). However, in various alternate embodiments, various other types of electronic systems and devices are equally contemplated. Therefore, these and other variations upon the discussed embodiments are intended to be covered by the present invention, which is limited only by the appended claims.

What is claimed is:

1. An apparatus for effectively controlling an electronic system, comprising:
a display panel that is configured to selectively display sets of control symbols that represent control commands for controlling a plurality of electronic devices in said electronic system;
a switch matrix that is transparently implemented to include control switches that are each aligned over a corresponding respective one of said control symbols on said display panel; and
a button panel that includes control buttons that are positioned to permit viewing said control symbols on said display panel through said control buttons, said control buttons being utilized for activating aligned ones of said control switches to select corresponding ones of said control commands.

2. The apparatus of claim 1 wherein said display panel, said switch matrix, and said button panel are implemented as part of a control assembly of a remote control.

3. The apparatus of claim 2 wherein said plurality of electronic devices include a television, a settop box, and one or more other electronic devices.

4. The apparatus of claim 1 further comprising a backlight array that includes an array of light sources that are aligned to shine light through said control symbols on said display panel and said control buttons on said button panel.

5. The apparatus of claim 4 wherein said backlight array is able to be turned on when there is insufficient ambient light, said backlight array being able to be turned off when there is sufficient ambient light.

6. The apparatus of claim 1 further comprising an assembly cover that includes button cutouts that fit over said control buttons of said button panel.

7. The apparatus of claim 2 wherein an RC configuration manager of said remote control reconfigures said display panel to display a specific one of said sets of control symbols that corresponds to a selected device control mode for controlling a particular one of said plurality of electronic devices.

8. The apparatus of claim 1 wherein said button panel is molded from a single piece of flexible material.

9. The apparatus of claim 1 wherein said display panel is implemented as a liquid-crystal display panel.

10. The apparatus of claim 1 wherein said control buttons each include a transparent button lens through which a corresponding one of said control symbols is visible.

11. The apparatus of claim 3 wherein an RC configuration manager of said remote control downloads RC configuration information that includes said control commands for said television, said settop box, and said one or more other electronic devices.

12. The apparatus of claim 11 wherein said settop box downloads said RC configuration information from an Internet configuration server, said RC configuration manager then downloading said RC configuration information from said settop box.

13. The apparatus of claim 12 wherein said remote control and said settop box bi-directionally and wirelessly communicate by utilizing high-speed radio-frequency communication techniques.

14. The apparatus of claim 11 wherein a personal computer downloads said RC configuration information from an Internet configuration server, said RC configuration manager then downloading said RC configuration information from said personal computer.

15. The apparatus of claim 14 wherein said remote control and said personal computer bi-directionally communicate by utilizing a hard-wired Universal Serial Bus dataport.

16. The apparatus of claim 11 wherein a system user utilizes a graphical-user-interface to initially associate said control commands with corresponding ones of said control buttons on said remote control.

17. The apparatus of claim 11 wherein a system user utilizes a graphical-user-interface to initially select said control symbols for corresponding ones of said control buttons on said remote control.

18. The apparatus of claim 11 wherein a system user utilizes said control assembly of said remote control to select a specific device control mode for controlling one of said plurality of electronic devices.

19. The apparatus of claim 18 wherein said system user scrolls through device names of said plurality of electronic devices, said device names being displayed in a liquid-crystal display window of said control assembly, said system user then selecting a desired one of said device names to thereby enter a corresponding device control mode.

20. The apparatus of claim 18 wherein said display panel of said control assembly displays one of said sets of control symbols corresponding to said specific device control mode, said system user then utilizing said control buttons to generate corresponding ones of said control commands to operate said one of said plurality of electronic devices.

21. A method for effectively controlling an electronic system, comprising the steps of:
configuring a display panel to selectively display sets of control symbols that represent control commands for controlling a plurality of electronic devices in said electronic system;
implementing a switch matrix to include control switches that are each transparently aligned over a corresponding respective one of said control symbols on said display panel;
providing a button panel with control buttons that are positioned to permit viewing said control symbols on said display panel through said control buttons; and
utilizing said control buttons for activating aligned ones of said control switches to select corresponding ones of said control commands.

22. The method of claim 21 wherein said display panel, said switch matrix, and said button panel are implemented as part of a control assembly of a remote control.

23. The method of claim 22 wherein said plurality of electronic devices include a television, a settop box, and one or more other electronic devices.

24. The method of claim 21 further comprising a backlight array that includes an array of light sources that are aligned to shine light through said control symbols on said display panel and said control buttons on said button panel.

25. The method of claim 24 wherein said backlight array is able to be turned on when there is insufficient ambient light, said backlight array being able to be turned off when there is sufficient ambient light.

26. The method of claim 21 further comprising an assembly cover that includes button cutouts that fit over said control buttons of said button panel.

27. The method of claim 22 wherein an RC configuration manager of said remote control reconfigures said display panel to display a specific one of said sets of control symbols that corresponds to a selected device control mode for controlling a particular one of said plurality of electronic devices.

28. The method of claim 21 wherein said button panel is molded from a single piece of flexible material.

29. The method of claim 21 wherein said display panel is implemented as a liquid-crystal display panel.

30. The method of claim 21 wherein said control buttons each include a transparent button lens through which a corresponding one of said control symbols is visible.

31. The method of claim 23 wherein an RC configuration manager of said remote control downloads RC configuration information that includes said control commands for said television, said settop box, and said one or more other electronic devices.

32. The method of claim 31 wherein said settop box downloads said RC configuration information from an Internet configuration server, said RC configuration manager then downloading said RC configuration information from said settop box.

33. The method of claim 32 wherein said remote control and said settop box bi-directionally and wirelessly communicate by utilizing high-speed radio-frequency communication techniques.

34. The method of claim 31 wherein a personal computer downloads said RC configuration information from an Internet configuration server, said RC configuration manager then downloading said RC configuration information from said personal computer.

35. The method of claim 34 wherein said remote control and said personal computer bi-directionally communicate by utilizing a hard-wired Universal Serial Bus dataport.

36. The method of claim 31 wherein a system user utilizes a graphical-user-interface to initially associate said control commands with corresponding ones of said control buttons on said remote control.

37. The method of claim 31 wherein a system user utilizes a graphical-user-interface to initially select said control symbols for corresponding ones of said control buttons on said remote control.

38. The method of claim 31 wherein a system user utilizes said control assembly of said remote control to select a specific device control mode for controlling one of said plurality of electronic devices.

39. The method of claim 38 wherein said system user scrolls through device names of said plurality of electronic devices, said device names being displayed in a liquid-crystal display window of said control assembly, said system user then selecting a desired one of said device names to thereby enter a corresponding device control mode.

40. The method of claim 38 wherein said display panel of said control assembly displays one of said sets of control symbols corresponding to said specific device control mode, said system user then utilizing said control buttons to generate corresponding ones of said control commands to operate said one of said plurality of electronic devices.

41. An apparatus for effectively controlling an electronic system, comprising:
means for selectively displaying sets of control symbols that represent control commands for controlling a plurality of electronic devices in said electronic system;
means for implementing control switches that are each transparently aligned over a corresponding respective one of said control symbols;
means for positioning control buttons to permit viewing said control symbols through said control buttons; and
means for activating aligned ones of said control switches to select corresponding ones of said control commands.

42. A remote control for effectively controlling a television system, comprising:
a liquid-crystal display panel configured to selectively display sets of control symbols that represent control commands for controlling a plurality of electronic devices in said electronic system, said electronic devices including a television, a settop box, and one or more other electronic devices;
a switch matrix that is transparently implemented to include control switches that are each aligned over a corresponding respective one of said control symbols on said liquid-crystal display panel; and
a button panel that includes control buttons that are transparently positioned to permit viewing said control symbols on said liquid-crystal display panel through said control buttons, said control buttons being utilized for activating aligned ones of said control switches to select corresponding ones of said control commands, said remote control downloading said sets of said control commands for said plurality of electronic devices from a configuration server on the Internet.

43. An apparatus for effectively controlling an electronic system, comprising:
means for selectively displaying sets of control symbols that represent control commands for controlling a plurality of different electronic devices; and
means for positioning control buttons to permit viewing said control symbols through said control buttons for selecting corresponding ones of said control commands.
